(19) United States
(12) Patent Application Publication
(10) Pub. No.: US 2007/0262959 A1
(43) Pub. Date: Nov. 15, 2007

(54) Magnetic joystick

(75) Inventor: Huan-Lung Gu, Hualien City (TW)

Correspondence Address: BRUCE H. TROXELL;SUITE 1404, 5205 LEESBURG PIKE, FALLS CHURCH, VA, 22041, US

(73) Assignee: INDUSTRIAL TECHNOLOGY RESEARCH INSTITUTE

(21) Appl. No.: 11/432,629

(22) Filed: May 12, 2006

(51) Int. Cl. G09G 5/08

(52) U.S. Cl. 345/161

(57) ABSTRACT

A magnetic joystick is disclosed, which comprises: a control stick, having a handle; a spring, ensheathing the control stick; a spring seat, arranged underneath the spring; a base, arranged underneath the spring seat while supporting the same; a pivotal joint, arranged on the base while having an opening enabling the control stick to be fitted therein and extend therefrom; a carrier disk, arranged under the pivotal joint while connecting to the bottom of the control stick to be driven thereby; and a plurality of magnetic sensors; wherein, a plurality of magnets are positioned on the carrier disk while enabling the polarities of the plural magnets to be interlaced aligned; and each of the plural magnetic sensors is disposed at a position corresponding to the plural magnets so as to use the detection of the intensity change of magnetic field, caused by the translation of the carrier disk, for evaluating the location of the carrier disk.

### FIELD OF THE INVENTION

The present invention relates to a joystick, and more particularly, to a magnetic joystick having a plurality of magnets positioned on a carrier disk at positions corresponding to a plurality of magnetic sensors in respective while enabling the polarities of the plural magnets to be interlaced aligned, so that the position of the carrier disk can be evaluated by detecting of the variation of magnetic field intensity caused by the translation of the carrier disk.

### BACKGROUND OF THE INVENTION

A joystick is a general control device or position signal generator, consisting of a handheld stick that pivots about one end and transmits its angle in two or three dimensions to a computer, which are used for controlling machines such as video games, unmanned aircrafts, and powered wheelchairs, etc. Basing on the manner of generating position signals, joysticks can be divided into two types, that is, the contact-type and non-contact type. Between the two types of joystick, the non-contact type joystick is more robust since it has less moving parts than that of the contact type joystick. Some early joysticks use small-sized coils to sense the variation of electric current flowing therein while developing electric signals representing the variation. Nowadays, a means of magnetic field induction is commonly adopted by most non-contact joysticks for detecting the movement of the same through the cooperation of induced magnets and magnetic sensors. In such magnetic joystick, the variations of magnetic field intensity are detected by the magnetic sensors as the control stick of the joystick is deflected and thus current or voltage signals representing such variations are developed accordingly.

A magnetic joystick is disclosed in U.S. Pat. No. 5,850,142, entitled “CONTROL DEVICE HAVING A MAGNETIC COMPONENT WITH CONVEX SURFACES”, which integrates the ball joint of the control stick thereof and the induced magnets by the use of a specific magnetic material. Although the structure of the aforesaid joystick is simple, the use of the specific magnetic material and the manufacturing process thereof make the cost of such joystick to be much higher than other joysticks, such that it is not commercially feasible.

Therefore, it is in need of a magnetic joystick that not only is not subject to the limitations and shortcomings of prior-art joystick, but also is simple in construction and inexpensive to fabricate.

### SUMMARY OF THE INVENTION

In view of the disadvantages of prior art, the primary object of the present invention is to provide a magnetic joystick having a plurality of magnets positioned on a carrier disk at positions corresponding to a plurality of magnetic sensors in respective while enabling the polarities of the plural magnets to be interlaced aligned, so that the position of the carrier disk can be evaluated by the detecting the variation of magnetic field intensity caused by the translation of the carrier disk.

It is another object of the invention to provide a magnetic joystick having a pressure switch arranged thereon, by which an electrical signal is transmitted to a controller for enabling the same to carry out a command corresponding to the electrical signal as the pressure switch is activated.

To achieve the above objects, the present invention provides a magnetic joystick, which comprises: a control stick, having a handle; a spring, ensheathing the control stick; a spring seat, arranged underneath the spring; a base, arranged underneath the spring seat while supporting the same; a pivotal joint, arranged on the base while having an opening enabling the control stick to be fitted therein and extend therefrom; a carrier disk, arranged under the pivotal joint while connecting to the bottom of the control stick to be driven thereby; and a plurality of magnetic sensors; wherein, a plurality of magnets are positioned on the carrier disk while enabling the polarities of the plural magnets to be interlaced aligned; and each of the plural magnetic sensors is disposed at a position corresponding to the plural magnets so as to use the detection of the intensity change of magnetic field, caused by the translation of the carrier disk, for evaluating the position of the carrier disk

Preferably, the control stick is a hollow tube while the handle arranged therein is further comprised of a pressure switch, which can issue an electrical signal to a controller for enabling the same to carry on a command corresponding to the electrical signal as the pressure switch is activated.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an exploded diagram showing a magnetic joystick according to a preferred embodiment of the invention, which is composed of FIG. 1A and FIG. 1B.

FIG. 2 is a cross sectional view of the magnetic joystick of FIG. 1.

FIG. 3 is a schematic diagram illustrating the magnetic joystick of FIG. 2 being deflecting.

FIG. 4 is a top view of a pivot joint shown in FIG. 1.

FIG. 5 is a top view of a carrier disk shown in FIG. 1.

FIG. 6 is a schematic diagram showing an arrangement of Hull-effect sensors with respect to magnets according to a first embodiment of the invention.

FIG. 7 is a schematic diagram showing an arrangement of Hull-effect sensors with respect to magnets according to a second embodiment of the invention.

FIG. 8 is a schematic diagram showing an arrangement of Hull-effect sensors with respect to magnets according to a third embodiment of the invention.

FIG. 9 is a schematic view of a carrier disk used in the first preferred embodiment of the invention.

FIG. 10 is a schematic view of a carrier disk used in the third preferred embodiment of the invention.

FIG. 11 is a cross sectional view of the magnetic joystick according to the second embodiment of the invention.

FIG. 12 is an exploded diagram showing a magnetic joystick according to a embodiment of the invention, which is composed of FIG. 12A and FIG. 12B.

FIG. 13 is a cross sectional view of the magnetic joystick of FIG. 12

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

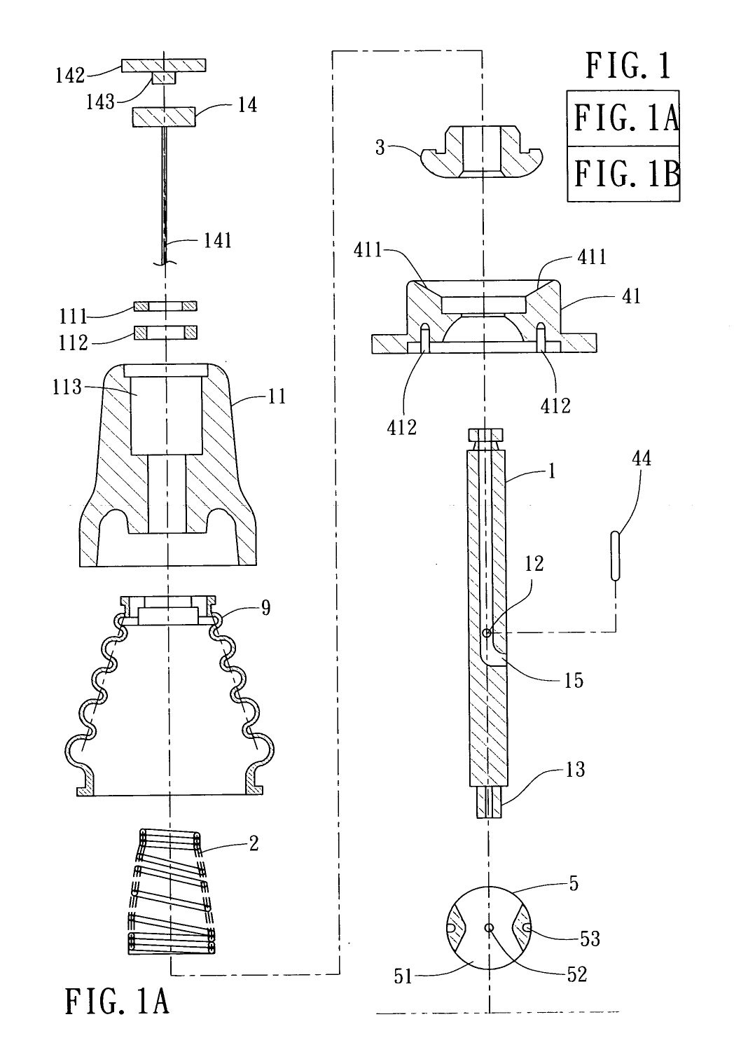

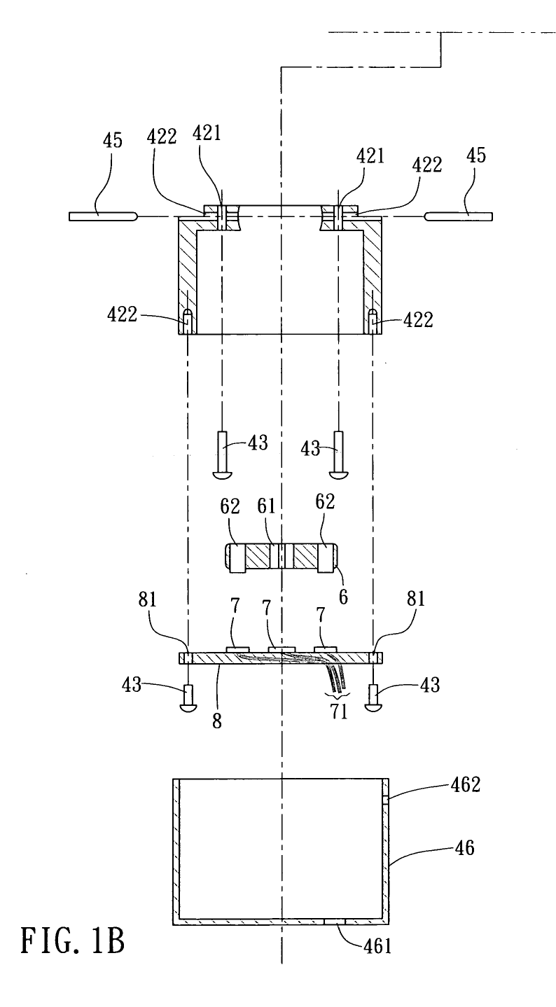

Please refer to FIG. 1 and FIG. 2, which are respectively an explode view and a cross sectional view of a magnetic joystick according to the present invention, whereas the exploded view is composed of FIG. 1A and FIG. 1B. The magnetic joystick of FIG. 1 is comprised of a control stick 1, a spring 2, a spring seat 3, a base 4, a pivotal joint 5, a carrier disk 6 and a plurality of Hull-effect sensors 7. Wherein, the control stick 1 is substantially a hollow tube having a handle 11, whereas the handle 11 is connected to the control stick 1 by a snap ring 111 and a padding 112. The spring 2 is ensheathing the control stick 1 at the portion thereof beneath the handle 11, whereas the spring 2 is tapered for holding the control stick fixed to a neutral position. The spring seat 3 is arranged underneath the spring 2 while supporting the same, whereas an opening is arranged on the spring seat 3 for enabling the same to ensheathe the control stick 1 therethrough and the bottom of the spring seat 3 is convex. The base 4 is arranged underneath the spring seat and is composed of a upper base 41 and a lower base 42, wherein the upper base 41 has a concave supporting part 411 for receiving the convex bottom of the spring seat 3, such that the control stick deflected by an external force can move back to the neutral position after it is free from the external force by the reaction between the convex bottom of the spring seat 3, the concave supporting part 411 and the spring 2.

Moreover, the upper base 41 has at least a screw hole 412 while the lower base 42 has at least a fix hole 421, such that the upper base 41 can be secured to the low base 42 for combining the two into an integrated unit by inserting a screw 43 through the fix hole 421 and secured onto the screw hole 412 corresponding to the fix hole 421. As the upper base 41 is connected to the lower base 42, a space is formed in the integrate unit for accommodating the pivotal joint 5. The pivotal joint has an opening 51, which is used for enabling the control stick 1 to be fitted therein and extend therefrom, and thus to rigidly connect to the carrier disk 6 placed underneath the pivotal joint 5. The control stick 1 is rigidly connected to the carrier disk 6 so that the carrier disk 6 can be driven to move by the control disk 1, whereas the rigid connection can be realized by the secure of a screw. As the control stick 1 is inserted and passing the opening of the pivotal joint 5, the control stick 1 can be secured to the pivotal joint 5 by inserting a first position pin 44 through a first positioning hole 52 of the pivotal joint 5 and a positioning hole 12 of the control stick 1 while inserting two second position pins 45 through the pin holes 422 respectively arranged at the two sides of the lower base 42 to be secured to the two second positioning holes 53 of the pivotal joint 5 in respective, such that the control stick 1 is able to rotate about the first position pin 44 for performing a movement of one-degree-of-freedom, or to rotate about the second position pin 45 for performing another movement of one-degree-of-freedom.

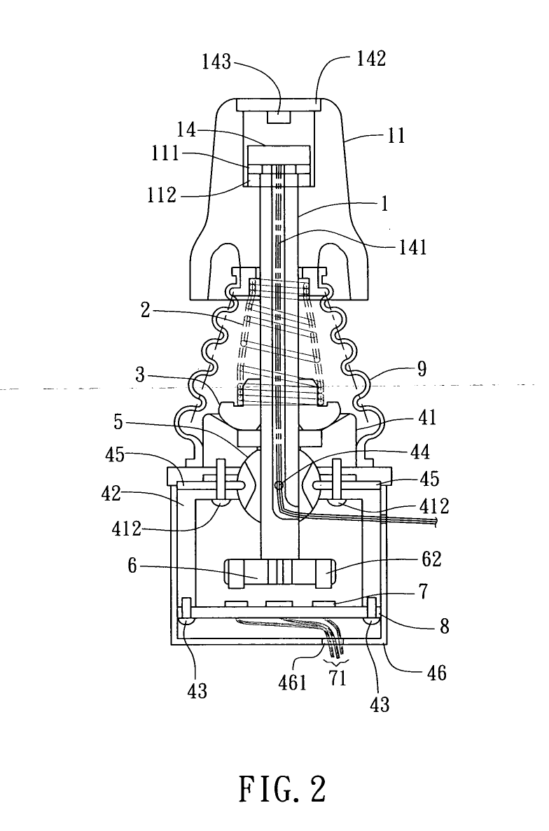

The carrier disk 6 has a connection hole 61, which is used to connect to the plug 13 arranged at an end of the control stick 1. By inserting the plug 13 into the connection hole 61, the carrier disk 6 can be driven to perform a movement of two-degree-of-freedom with respect to the deflection of the control stick 1. In addition, a plurality of magnets 62 are positioned on the carrier disk 6 while enabling each of the plural Hull-effect sensors 7 to be disposed at a position corresponding to the plural magnets 62. In the preferred embodiment shown in FIG. 1B, the plural Hull-effect sensors 7 are disposed on a circuit board 8. As the deflection of the control stick 1 drives the carrier disk 6 to move accordingly, the intensity change of magnetic field caused by the translation of the carrier disk 6 can be detected by the plural Hull-effect sensors 7 while enabling the plural Hull-effect sensors 7 to issue electrical signals corresponding to the intensity change to a controller through signal lines 71 connected respectively to the plural Hull-effect sensors 7, such that the position of the carrier disk 6 can be determined. The signal line 71 are extending from the plural Hull-effect sensors 7 to the outside world and connected to the controller through a first aperture 461 formed on a protective casing 46. Since the moving path of the carrier disk 6 is defined by the deflection of the control stick 1 in a one-to-one manner, the electrical signals generated with respect to the movement of the carrier disk 6 by the plural Hull-effect sensors 7 can be used for determining the position of the control stick 1, as shown in FIG. 3, which is a schematic diagram illustrating the magnetic joystick of FIG. 2 being deflecting.

The lower base 42 also has at least a screw hole 423, that the circuit board 8 can be fixedly arranged under the base 4 by inserting a screw 43 through a fix hole 81 of the circuit board 8 and secured onto the screw hole 423 corresponding to the fix hole 81. Furthermore, an elastic dust cover 9 is arranged between the handle 11 and the base 4 for not only preventing the joystick being contaminated by dust and foreign objects, but also preventing the leakage of lubricating oil disposed on parts of the joystick. In addition, as the protective casing 46 is covering the exterior of the lower base 41, the parts of the joystick are further protected.

In a preferred aspect, a pressure switch 14 can be arranged on the handle 11 using the space 113 available in the handle 11, whereas the pressure switch can be a piezo-electric crystal or a strainer. Moreover, the signal line 141 of the pressure switch 14 is guided out of the space 113 through an aperture 15 formed on the side wall of the control stick 1 while it is further guided to extending to the outside world through the second aperture 462 of the protective casing 46 and connected to the controller. As the cap 142 of the handle 11 is subjected to an external force, the contact point 143 is forced down to press on the pressure switch 14 for activating the pressure switch 14. In addition, As the bottom of the handle 11 is subjected to the resilience force provided by the spring 2, the pressure exerting on the pressure switch 14 must exceed a specific limit so as to activate the pressure switch 14 that can prevent the pressure switch 14 from being activated by accident.

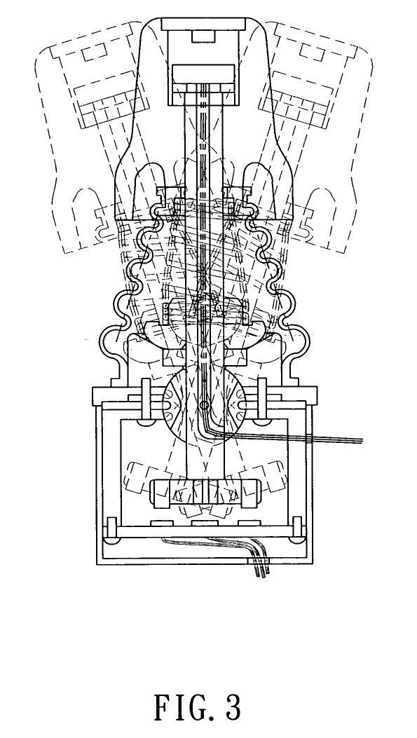

Please refer to FIG. 4, which is a top view of a pivot joint shown in FIG. 1. The pivotal joint 5 comprises an opening 51, a first positioning hole 52 and two second positioning holes 53.

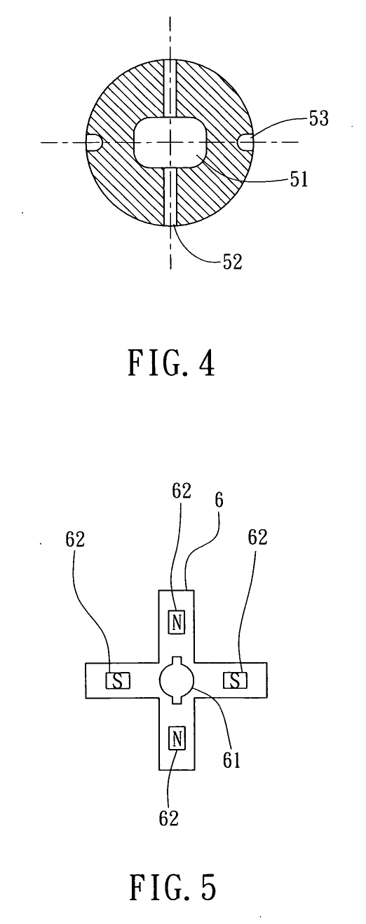

Please refer to FIG. 5, which is a top view of a carrier disk shown in FIG. 1. As seen in FIG. 5, the carrier disk 6 is a crisscross planar plate, but it can be formed in shapes other than the crisscross shown in FIG. 5. The carrier disk 6 has a connection hole 61, which is used to connect to the plug 13 arranged at an end of the control stick 1. Moreover, four magnets 62 are positioned on the carrier disk 6 while enabling the polarities of the four magnets 62 to be interlaced aligned, i.e. the polarity of any one of the four magnets 62 is opposite to that of another magnet disposed next thereto.

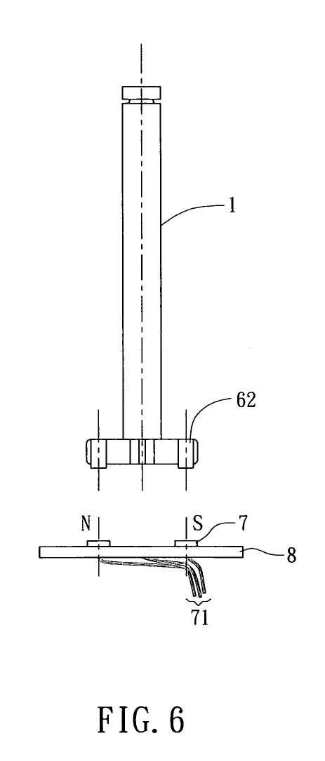

Please refer to FIG. 6, which is a schematic diagram showing an arrangement of Hull-effect sensors with respect to magnets according to a first embodiment of the invention. For clarity, two magnets 62 disposed on a carrier disk 6 of planar plate are used as illustration. In the first embodiment, the axis of polarization of each magnet of the two magnets 62, characterized by its north and south magnetic poles, is aligned parallel to the longitudinal axis of the control stick 1 while enabling the polarities of the two magnets 62 on the same surface to be opposite to each other. Furthermore, the sensitive axes of the two Hull-effect sensors 7 corresponding to the two magnets are aligned parallel to the longitudinal axis of the control stick 1.

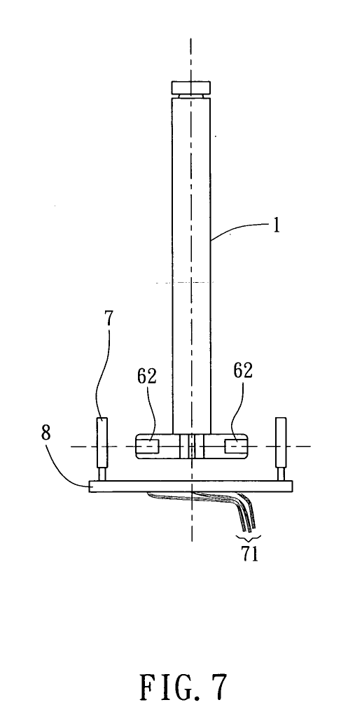

Please refer to FIG. 7, which is a schematic diagram showing an arrangement of Hull-effect sensors with respect to magnets according to a second embodiment of the invention. Similarly, for clarity, two magnets 62 disposed on a carrier disk 6 of planar plate are used as illustration. In the second embodiment, the axis of polarization of each magnet of the two magnets 62, characterized by its north and south magnetic poles, is aligned perpendicular to the longitudinal axis of the control stick 1 while enabling the polarities of the two magnets 62 on the same surface to be opposite to each other. Furthermore, the sensitive axes of the two Hull-effect sensors 7 corresponding to the two magnets are aligned perpendicular to the longitudinal axis of the control stick 1.

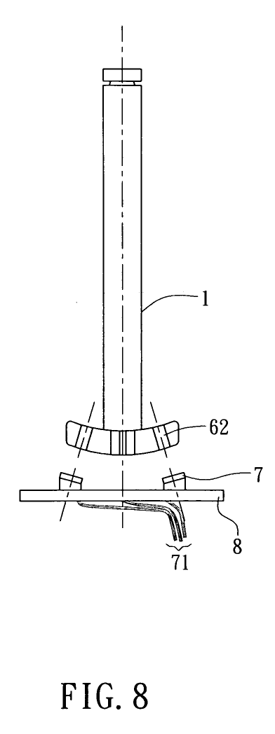

Please refer to FIG. 8, which is a schematic diagram showing an arrangement of Hull-effect sensors with respect to magnets according to a third embodiment of the invention. Other than the aforesaid embodiment, the two magnets 62 are disposed on a carrier disk 6 of convex plate, which are used as illustration. In the third embodiment, as the carrier disk 6 is convex, the axis of polarization of each magnet of the two magnets 62, characterized by its north and south magnetic poles, is aligned to incline to the longitudinal axis of the control stick by a less than 90 degrees inclination angle while enabling the polarities of the two magnets 62 on the same surface to be opposite to each other. Furthermore, the sensitive axes of the two Hull-effect sensors 7 corresponding to the two magnets are aligned to incline to the longitudinal axis of the control stick 1 by a inclination angle the same as that of the magnet 62 corresponding thereto, such that the sensitive axes of the Hull-effect sensors 7 is aligned parallel to the axis of polarization of the magnet corresponding thereto.

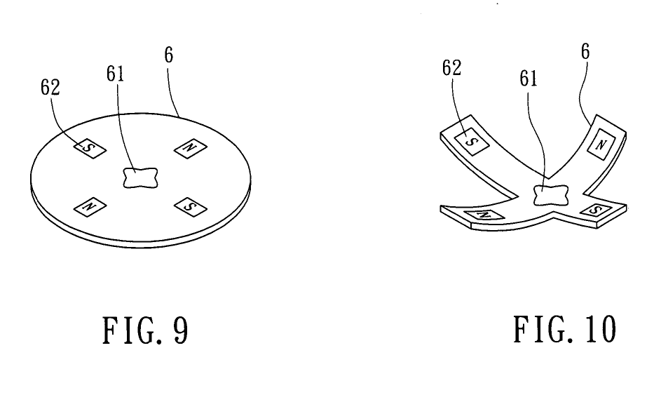

Please refer to FIG. 9, which is a schematic view of a carrier disk used in the first preferred embodiment of the invention. The carrier disk 6 of FIG. 9 is a round planar plate having four magnets 62 equiangularly spaced and disposed thereon while enabling the polarity of any one of the four magnets to be opposite to that of its neighbor magnets, i.e. the polarities of any two neighboring magnets are opposite to each other. It is noted that although the carrier disk 6 shown in FIG. 9 is a round planar plate, it is not limited thereby and thus can be a planar plate of any shape under the condition that it is capable of enabling magnets to be equiangularly spaced and disposed thereon, such as a polygon, a crisscross, or other irregular shapes.

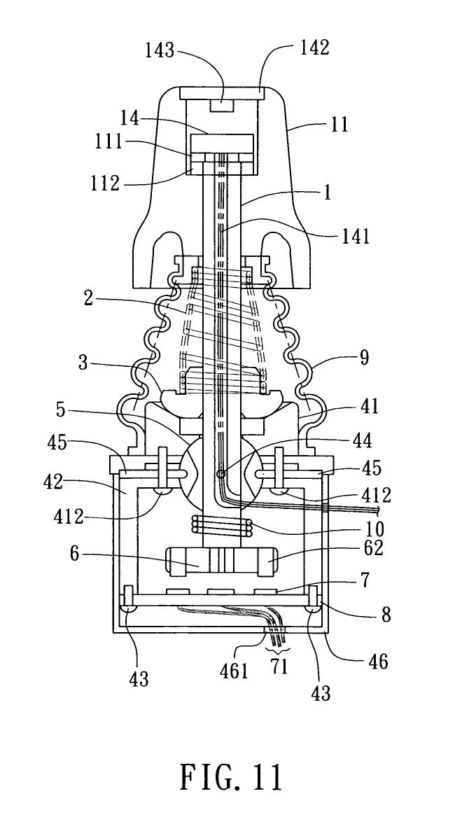

Please refer to FIG. 10, which is a schematic view of a carrier disk used in the third preferred embodiment of the invention. The carrier disk of FIG. 10 is a crisscross convex plate having four magnets 62 equiangularly spaced and disposed thereon while enabling the polarity of any one of the four magnets to be opposite to that of its neighbor magnets, i.e. the polarities of any two neighboring magnets are opposite to each other. Similarly, although the carrier disk 6 shown in FIG. 9 is a crisscross convex plate, it is not limited thereby and thus can be a convex plate of any shape under the condition that it is capable of enabling magnets to be equiangularly spaced and disposed thereon, such as a polygon, a circular, or other irregular shapes. Moreover, by the application of a carrier disk 6 of convex plate, the variation of height of a Hull-effect sensor 7 is coordinated to that of its corresponding magnet 62, so that the signal detected by the Hull-effect sensor is a linear signal.

Although the number of magnet 62 used in the embodiments shown in FIG. 6 to FIG. 10 are either two or four, it is only used as illustration and is not limited thereby, the only restriction is that a plurality of magnets are positioned on the carrier disk while enabling the polarities of the plural magnets to be interlaced aligned, i.e. the polarities of any two neighboring magnets are opposite to each other and thus the number of the plural magnet should be always a multiple of two. In addition, as the deflection of the control stick will drive the carrier disk to move accordingly, the distance measured between one of the plural magnets disposed on the carrier and it corresponding Hull-effect sensor will be varied while causing the magnetic field intensity to changed accordingly. Meanwhile, the Hull-effect sensor is enabled to generate different electrical signals with respect to the change of the magnetic field intensity while transmitting the electrical signals to a controller so as to direct the same to carry out a command corresponding to the electrical signals.

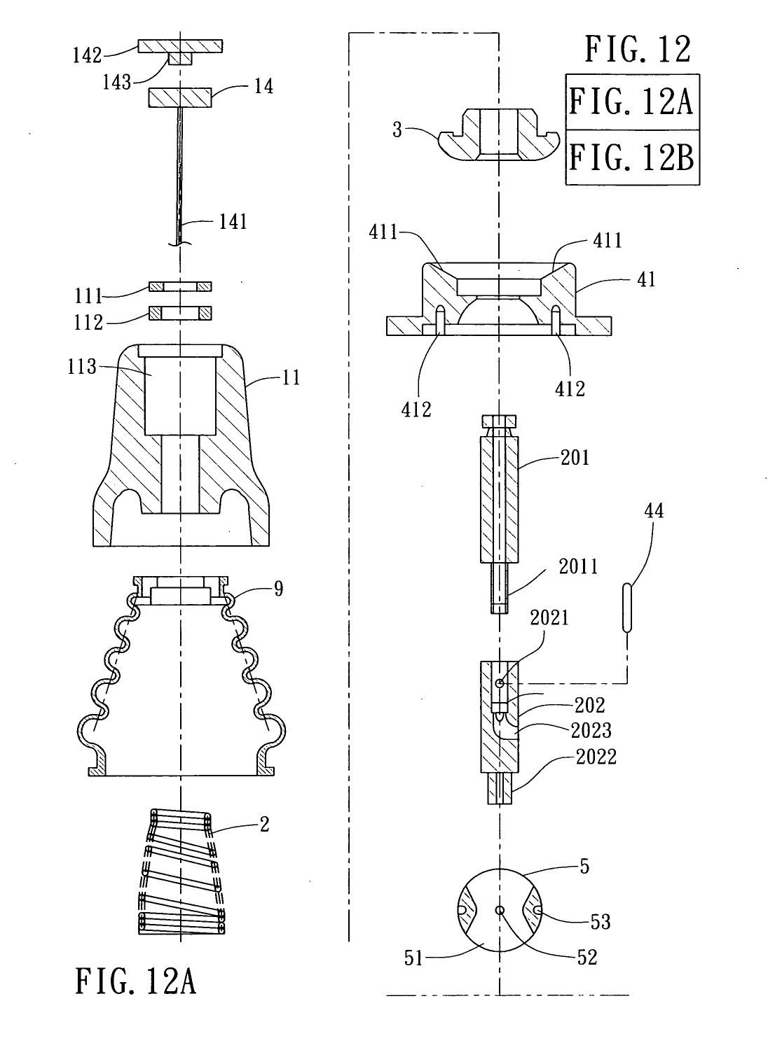

Please refer to FIG. 11, which is a cross sectional view of the magnetic joystick according to the second embodiment of the invention. As seen in FIG. 11, the control stick 1 is loosely connected to the carrier disk 6, such as a pivotal connection formed by a pin, by which the carrier disk 6 is enabled to move relative to the deflection of the control stick 1. In addition, for preventing the drastic moving of the carrier disk 6 from obstructing the homing of the same, a force feedback spring is arranged surrounding the control stick 1 at the portion thereof sandwiched between the carrier disk 6 and the lower base 42 for balancing the carrier disk 6 at a level status.

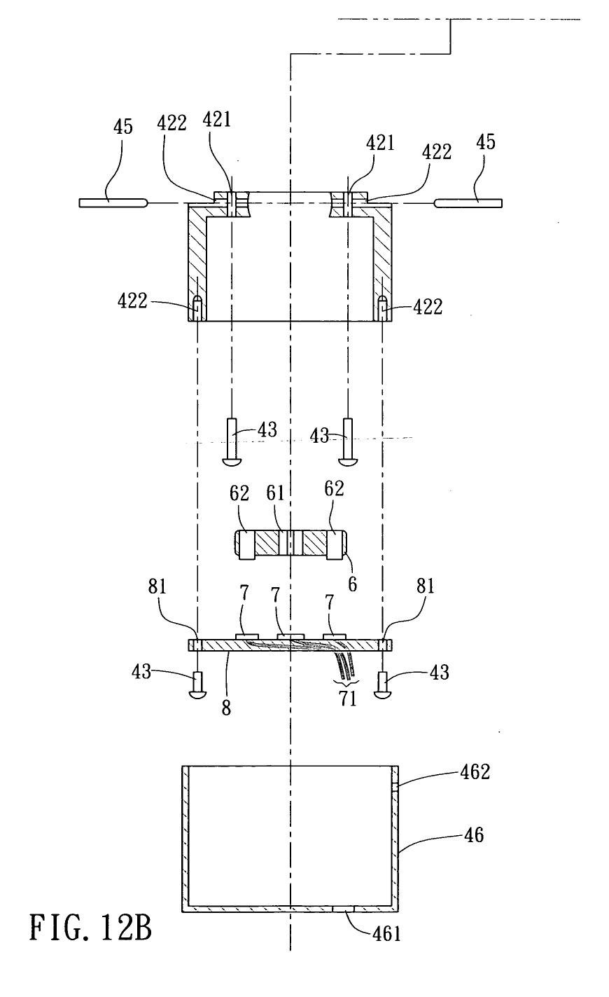

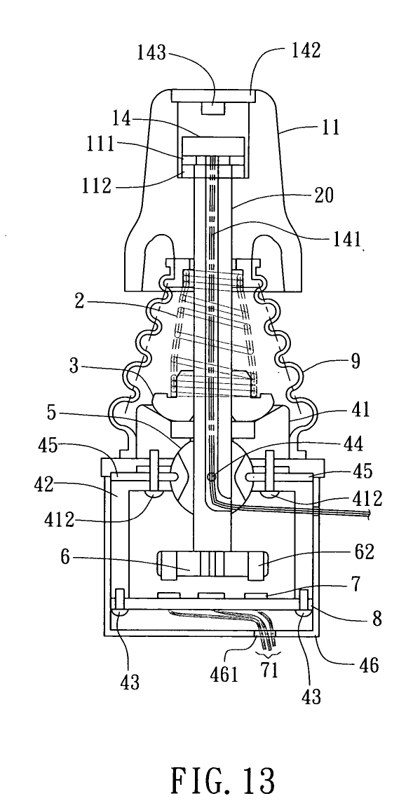

Please refer to FIG. 12 and FIG. 13, which are respectively an exploded diagram showing a magnetic joystick according to a preferred embodiment of the invention, which is composed of FIG. 12A and FIG. 12B, and a cross sectional view of the magnetic joystick of FIG. 12. In this preferred embodiment, a detachable control stick 20 is adopted in the magnetic joystick instead of the control stick 1 shown in the first preferred embodiment, which can facilitate the assembly of the magnetic joystick. As the detachable control stick 20 is used, the structure of the magnetic joystick of the present embodiment is slightly different to that of the first embodiment, which are listed as following:
(1) The detachable control stick 20 is composed of an upper stick 201 and a lower stick 202.
(2) The handle 11 is arranged on the top of the upper stick 201.
(3) The lower stick 202 is fitted into the opening of the pivotal joint 5 while enabling the top of the lower stick 202 to be fixedly connected to the plug 2011 of the bottom of the upper stick 201.
(4) The first position pin 44 pieces through the opening 51 of the pivotal joint 5 and the position hole 2021 of the lower stick for fixing the lower stick 202 onto the pivotal joint 5 while enabling the same to rotate about the first position pin 44 for performing a movement of one-degree-of-freedom.
(5) The lower stick 202 is connected to the carrier disk 6 by the use of a plug 2022 arranged at the bottom of the lower stick 202, so that the deflection of the detachable control stick 20 is able to drive the carrier disk 6 to move accordingly.

Similar to that shown in FIG. 1, both the upper stick 201 and the lower stick 202 can be made of hollow tubes while enabling a hole 2023 to be formed on a side of the lower stick 22, such that a pressure switch can be arranged on the detachable control stick 20. Other units of the magnet joystick shown in FIG. 12 is the same as that of FIG. 1 and thus is not described further herein. Moreover, if the plug 2022 is loosely connected to the carrier disk, a force feedback spring is arranged surrounding the lower stick 202 at the portion thereof sandwiched between the carrier disk and the pivotal joint, which is similar to that shown in FIG. 11.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A magnetic joystick, comprising:
a control stick, having a handle;
a spring, ensheathing the control stick;
a spring seat, arranged underneath the spring while supporting the same;
a base, arranged underneath the spring seat while supporting the same by a supporting part thereof;
a pivotal joint, arranged on the base while having an opening enabling the control stick to be fitted therein and extend therefrom;
a carrier disk, arranged under the pivotal joint while connecting to the bottom of the control stick to be driven thereby; and
a plurality of magnetic sensors;
wherein, a plurality of magnets are positioned on the carrier disk while enabling the polarities of the plural magnets to be interlaced aligned; and each of the plural magnetic sensors is disposed at a position corresponding to the plural magnets so as to use the detection of the intensity change of magnetic field, caused by the translation of the carrier disk, for evaluating the position of the carrier disk.

2. The magnetic joystick of claim 1, wherein the control stick is a hollow tube.

3. The magnetic joystick of claim 2, wherein the handle further comprises a switch for enabling an electrical signal to be issued and transmitted to a controller so as to direct the same to carry out a command corresponding to the electrical signal as the switch is activated.

4. The magnetic joystick of claim 3, wherein the electrical signal is transmitted by a signal line guided out by the use of the hollow tube and electrically connected to the controller.

5. The magnetic joystick of claim 4, wherein the switch is substantially a pressure switch capable of being activated while it is subjected to a pressure larger than a resisting force provided by the spring.

6. The magnetic joystick of claim 5, wherein the pressure switch is a device selected form the group consisting of a piezo-electric crystal and a strainer.

7. The magnetic joystick of claim 1, wherein the control stick is rigidly connected to the carrier disk for enabling the carrier disk to be driven to move by the control disk.

8. The magnetic joystick of claim 1, wherein the control stick is loosely connected to the carrier disk for enabling the carrier disk to be movable relative to the control stick.

9. The magnetic joystick of claim 8, wherein a force feedback spring is arranged surrounding the control stick at the portion thereof sandwiched between the carrier disk and the pivotal joint for balancing the carrier disk at a level status.

10. The magnetic joystick of claim 1, wherein the carrier disk is a planar plate.

11. The magnetic joystick of claim 1, wherein the carrier disk is a convex plate.

12. The magnetic joystick of claim 1, wherein a first positioning pin is arranged at the joint of the control stick and the pivotal joint for limiting the movable directions of the control stick.

13. The magnetic joystick of claim 1, wherein a second positioning pin is arranged at the base for limiting the movable directions of the pivotal joint.

14. The magnetic joystick of claim 1, wherein the axis of polarization of each magnet of the plural magnets, characterized by its north and south magnetic poles, is aligned parallel to the longitudinal axis of the control stick.

15. The magnetic joystick of claim 1, wherein the axis of polarization of each magnet of the plural magnets, characterized by its north and south magnetic poles, is aligned perpendicular to the longitudinal axis of the control stick.

16. The magnetic joystick of claim 1, wherein the axis of polarization of each magnet of the plural magnets, characterized by its north and south magnetic poles, is aligned to incline to the longitudinal axis of the control stick by a less than 90 degrees inclination angle.

17. The magnetic joystick of claim 14, wherein the sensitive axis of each magnetic sensor of the plural magnetic sensors is aligned parallel to the longitudinal axis of the control stick.

18. The magnetic joystick of claim 15, wherein the sensitive axis of each magnetic sensor of the plural magnetic sensors is aligned perpendicular to the longitudinal axis of the control stick.

19. The magnetic joystick of claim 16, wherein the sensitive axis of each magnetic sensor of the plural magnetic sensors is aligned parallel to the axes of polarization of the magnets corresponding thereto.

20. The magnetic joystick of claim 1, wherein the magnetic sensor is a Hull-effect sensor.

21. The magnetic joystick of claim 1, wherein the control stick is a detachable stick.
